(19) United States
(12) Patent Application Publication
(10) Pub. No.: US 2015/0264682 A1
(43) Pub. Date: Sep. 17, 2015

(54) METHOD AND APPARATUS FOR PROCESSING A SIGNAL

(71) Applicant: THE SECRETARY OF STATE FOR DEFENCE, Wiltshire (GB)

(72) Inventor: Stephen Charles Williams, Salisbury (GB)

(21) Appl. No.: 14/436,538

(22) PCT Filed: Oct. 23, 2013
(86) PCT No.: PCT/GB2013/000452

§ 371 Date: Apr. 17, 2015

(30) Foreign Application Priority Data
Oct. 24, 2012 (GB) 1219090.6

(51) Int. Cl. H04W 72/04; H04L 5/00; H04L 12/807; H04L 12/815; G06F 17/14

(52) U.S. Cl. CPC H04W 72/0446; H04L 47/225; G06F 17/141; H04L 47/27; H04L 5/0005

(57) ABSTRACT

The present invention relates to a method and apparatus for signal processing through the manipulation of a time-domain signal by using a conversion into the frequency domain comprising: forming (102) a plurality of overlapping time segments representing an input signal; applying a first window function to each of the overlapping time segments time segments and converting (103) the windowed overlapping time segments into respective frequency segments; converting (104) each of the respective frequency segments to respective time segments; and applying a composite window function to each of the respective time segments and combining (105) the windowed respective time segments to produce an output signal. The method is particularly useful for applications requiring the manipulation of a time signal in the frequency domain, for example in manipulating signal to noise ratios.

### TECHNICAL FIELD OF THE INVENTION

The present invention relates to the field of signal processing and, in particular, to a signal processor and signal processing method for addressing the problem of how to efficiently manipulate a time-domain signal by using a conversion into the frequency domain. Such processing has a large number of applications including, but not limited to, removing noise from signals and conducting sample-rate conversions between an input and an output signal.

### BACKGROUND TO THE INVENTION

It is often desirable to process a signal by converting between the time and frequency domains and, in order to do so, a number of techniques can be used. One such technique, which is commonly used, is Fourier Analysis. However, performing Fourier Analysis on a signal that is infinite in the time domain is generally considered to be computationally impractical. Therefore, in signal processing, it is typical to divide a signal into a number of segments in the time domain prior to applying a Fourier Transform.

In applying a Fourier Transform to a finite time segment it is typically assumed that the input sampled signal is periodic. The result is a spectral output which is analogous to that which would have been produced by the time segment had it been repeated without end. One of the problems of this approach is that any frequency discontinuity, caused by abrupt transitions of the signal at the start and/or end of the time segment, can result in an undesirable distortion of the frequency response of the signal. Traditionally, such frequency distortions are managed by applying an appropriate window function to the time segment to minimise these abrupt start and end transitions.

A disadvantage of using window functions is that there can be a reduction in frequency resolution, particularly at the start and end sections of the time segment. A common technique to mitigate the loss of frequency resolution is to process a number of overlapping time segments. After processing, the overlapping time segments may be recombined to produce a continuous signal in the time domain by the summation of the segments with the appropriate time overlap. The time segments overlap each other, for example by an overlap proportion of 50%, with respect to adjacent time segments. Then, one half of the time duration of a time segment overlaps with one half of the time duration of an immediately preceding time segment, and the other half of the time duration of the time segment overlaps with one half of the time duration of an immediately following time segment. The greater the overlap proportion, the higher the number of time segments that are required to cover a given time duration. This processing and recombination of the overlapping time segments results in high complexity and computational burden. This complexity is proportional to the overlap proportion of the time segments.

It is considered that, depending on the signal processing application, some window functions provide better performance than others in preserving the integrity of the input signal. However, several of the window functions which perform favourably in preserving signal integrity ideally require a large overlap proportion when recombining the signal. In particular, summing the window function when overlapped by the same proportion as the time windows should result in a constant value to avoid distortion in the output signal. Therefore, a common problem of using window functions is the need, based on the signal processing application, to compromise either the efficiency of the processing or the integrity of the output signal.

An additional drawback of using window functions is the frequent introduction of large numerical ranges over which many window functions operate. This is particularly the case for those window functions that reduce the time segments close to zero along the start and end of the window function. In such cases, applying the inverse of the original window function results in large values and so typically requires processing signal data over a large numerical range, resulting in high complexity and either requiring high processing power or a long duration of time in order to cope with the processing burden.

It is therefore an aim of the present, invention to provide an improved signal processing method and system for manipulating a time-domain signal by using a conversion into the frequency domain.

### SUMMARY OF THE INVENTION

According to an embodiment of the invention, there is provided a signal processing method comprising: forming a plurality of overlapping time segments representing an input signal; applying a first window function to each of the overlapping time segments and converting the windowed overlapping time segments into respective frequency segments; converting each of the respective frequency segments to respective time segments; and applying a composite window function to each of the respective time segments and combining the windowed respective time segments to produce an output signal; wherein the composite window function is a combination of to an inverse of the first window function and a second window function, the second window function summing to a constant value when overlapped by a same overlap as the overlaps of the overlapping time segments.

According to another embodiment of the invention, there is provided a signal processor configured to: receive an input signal; form a plurality of overlapping time segments representing the input signal; apply a first window function to each of the overlapping time segments and convert the windowed overlapping time segments into respective frequency segments; convert each of the respective frequency segments to respective time segments; and apply a composite window function to each of the respective time segments and combine the windowed respective time segments to produce an output signal, wherein the composite window function is a combination of an inverse of the first window function and a second window function, the second window function summing to a constant value when overlapped by a same overlap as the overlaps of the overlapping time segments.

In using the second window function, a constant value can be achieved when summing the composite window function overlapped by the same proportion as the time windows even if the first window function used does not give a constant value when summed by the same overlapped proportion.

The application of the second window function does not significantly distort the data since the second window function sums to a constant value when overlapped according to the overlap proportion of the overlapping time segments.

The constant value is clearly a substantially constant value that is sufficiently constant to provide a good reconstruction of the time domain signal, for example quantisation errors may mean the constant value is not perfectly constant.

Since the composite window function is dependent on the differences between the first and second window functions, which are typically quite small, the dynamic range of the composite window function is significantly smaller than that of the inverse of the first window function. Consequently, a significant saving of processing resources may be achieved.

It would be clear to those skilled in the art that the present invention may be advantageously applied in a number of signal processing fields and therefore that the input signal clearly represents a signal which could have been obtained from any one of a large number of sensors. Examples of such signals and their fields of applications include, but are not limited to, signal to noise reduction of microwave satellite communications signals; sample rate conversion of analogue audio signals; and signal to noise reduction of weather monitoring radar signals.

Preferably, the first window function has characteristics favourable for maintaining the integrity of the signal and the second window function has characteristics favourable for minimising the number of overlapping time segments required to produce an output signal.

Applying a first window function that is suited to maintaining the integrity of the signal enables the time segments to be converted from the time domain into the frequency domain in a manner which is advantageous to maintain the integrity of the output signal. When converting the frequency segments back into time segments, signal processing efficiency can be improved by applying a composite window function that is a combination of the inverse of the first window function and a second window function. The second window function has characteristics favourable for minimising the number of overlapping time segments required to produce an output signal of good integrity. This combines the signal integrity advantages of the first window function with the process efficiency of the second window function.

Advantageously, the first window function may be a four term window function and there may be, for example, a 50% overlap between the time segments.

Four term window functions, for example the four term Blackman-Harris Window function, provide properties which are suited to maintaining good signal integrity across a range of applications, but typically require the summing of time segments which overlap by a large proportion to achieve a constant value. For the four term Blackman-Harris Window Function this overlap proportion is typically 75%. However, using such a first window function in combination with the composite window function according to the invention, allows a constant value to be achieved using an overlap proportion between time segments that is lower than that required when using the first window function alone.

Advantageously, the second window function may be a function that adds to a constant value using an overlap of 50%, for example the Hann Window Function.

The Hann window function may be defined as follows:

$${w}_{H} = 0.5 - 0.5 cos ( \frac{2 π n}{N - 1} )$$

Window functions such as the Hann Window Function may be used in combination with a first window function such as the Blackman-Harris Window Function, which is suited to maintaining the integrity of the signal, to achieve a good balance between signal processing efficiency and signal integrity. For example, the four term Blackman-Harris window function that normally requires segments overlapping by 75% to sum to a constant value, may be implemented with segments that only overlap by 50% whilst still maintaining a constant value, by virtue of the Hann Window Function being used in the composite window function.

The 50% overlap between the time segments is clearly a substantially 50% overlap, the overlap being sufficient to provide a good reconstruction of the time domain signal.

Advantageously, the conversion of the overlapping time segments into respective frequency segments may be conducted using a Discrete Fourier Transform and/or the conversion of the frequency segments to respective time segments may be carried out using an inverse Discrete Fourier Transform.

The Discrete Fourier Transform (and its inverse) is generally considered to perform efficiently in the conversion of signal segments between time and frequency domains. Using the Discrete Fourier. Transform in conjunction with the combined window function is advantageous in achieving good signal processing efficiency.

Preferably, the time segments may be formed from the input signal using a signal sampling device.

The signal sampling device could be any device that is configured for sampling an input signal and outputting the sampled input signal within overlapping time segments, the overlapping time segments being temporally overlapping portions of the sampled input signal.

The use of a signal sampling device provides for an efficient method of obtaining the time segments.

Preferably, the signal processing method comprises manipulating the respective frequency segments before converting them to respective time segments. Accordingly, signal processing may be performed on the signal whilst it is in the frequency domain.

Advantageously, the overlapping time segments representing the input signal may have a first sampling rate and the respective time segments may have a second sampling rate, wherein the second sampling rate is different from the first sampling rate. The application of the composite window function to each of the respective time segments, and the combining of the respective time segments once they have been windowed by the composite window function, does not typically change the sampling rate, and so the sampling rate of the output signal is typically the same as the second sampling rate.

When converting the sample rate of an input signal to a different sampling rate, it is often desirable to convert the input signal from the time domain into the frequency domain. When converting between the time and frequency domains, the use of a composite window function enables a good level of both efficiency and signal integrity to be simultaneously achieved across a number of signal process applications.

Advantageously, the input signal may comprise a signal portion and a noise portion, and the ratio in the output signal between the signal portion and the noise portion may be greater than the ratio in the input signal between the signal portion and the noise portion by removing non-signal portion (noise portion) frequency components from the input signal whilst in the frequency domain.

The signal portion is any part of the input signal which is of interest.

The noise portion of the signal is any part of the input signal which is unwanted and which does not include the signal portion of the signal.

When converting between the time and frequency domains the use of a composite window function enables a good level of both efficiency and signal integrity to be simultaneously achieved across a number of signal process applications.

### BRIEF DESCRIPTION OF THE DRAWINGS

Embodiments of the invention will now be described by way of example only and with reference to the accompanying drawings, in which:

FIGS. 1a and 1b show an embodiment of the signal processing method for efficiently processing a time domain signal, by using a conversion into the frequency domain.

FIG. 2 shows an embodiment of the signal processing method in which the signal-to-noise ratio of the output signal is modified from that of the input signal.

FIG. 3 shows an embodiment of the signal Processing method in which the sampling rate of the output signal is modified from that of the input signal.

FIG. 4 shows an embodiment of the signal processor which is suitable for conducting the signal processing method of FIG. 1.

### DETAILED DESCRIPTION

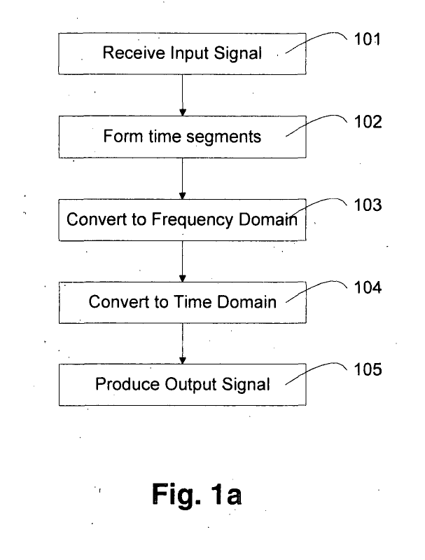

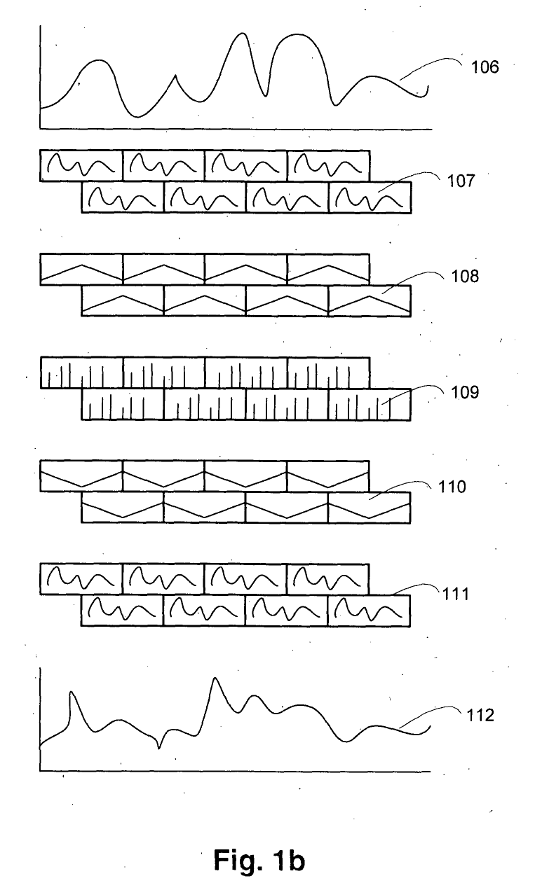

With reference to FIGS. 1a and 1b, in an embodiment of the signal processing method, time segments 107 overlapping by a proportion of 50% are formed 102 from an input signal 106 received in step 101. Frequency conversion 103 of the time segments 107 is conducted by applying four term Blackman-Harris Window Functions 108 to each of the time segments 107, and taking a Discrete Fourier . Transform of each of the time segments 107 once the four term Blackman-Harris Window Functions 108 have been applied to them, to generate corresponding overlapping frequency segments 109.

The four term Blackman-Harris Window function is defined as follows:

$${w}_{BH} = {a}_{0} - {a}_{1} cos ( \frac{2 π n}{N - 1} ) + {a}_{2} cos ( \frac{4 π n}{N - 1} ) + {a}_{3} cos ( \frac{6 π n}{N - 1} )$$

and where the coefficients have the values α₀=0.35875, α₁=−0.43329, α₂=0.14128, α₃=−0.01168

Time conversion 104 of the frequency segments 109 is conducted by taking an inverse Discrete Fourier Transform of each of the frequency segments 109. Once the frequency segments 109 have each been converted into the time domain, composite window functions 110 are applied to them, to give windowed respective time segments 111. Each composite window function 110 consists of the inverse of the four term Blackman-Harris Window Function combined with the Hann Window function.

The Hann window function is defined as follows:

$${w}_{H} = 0.5 - 0.5 cos ( \frac{2 π n}{N - 1} )$$

The output signal 112 is constructed 105 by summing the windowed time segments 111, which are at the 50% overlap proportion.

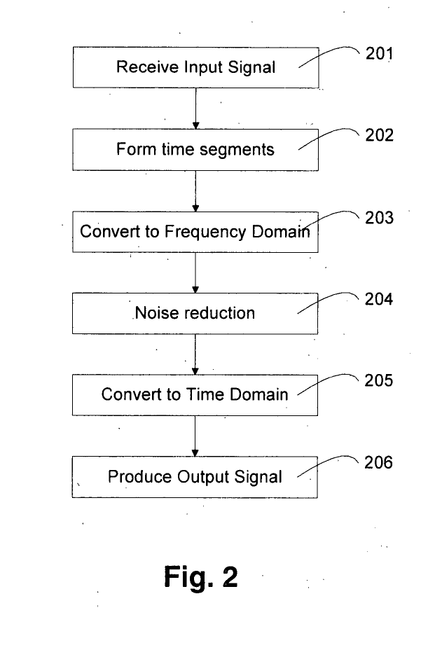

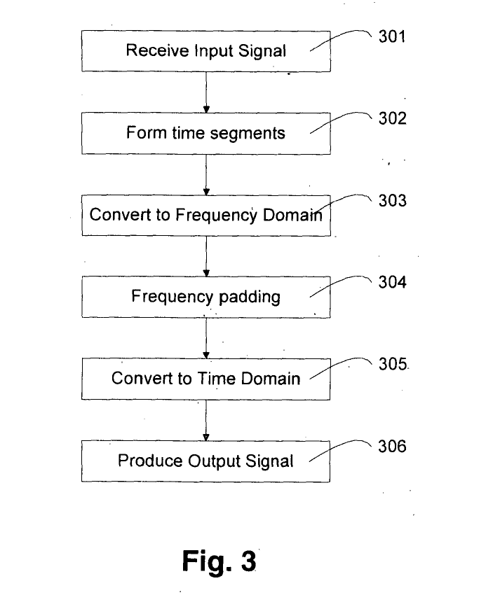

A variety of intermediate steps could be inserted to perform signal processing in the time domain, the frequency domain, or both; as will now be described in the embodiments of FIG. 2 and FIG. 3.

With reference to FIG. 2, in an embodiment of the signal processing method, time segments overlapping by a specified proportion are formed 202 from an input signal received at step 201. Conversion 203 of the time segments into the frequency domain is achieved by applying the first window function and then performing a Discrete Fourier Transform on each of the time segments. Noise reduction 204 is then performed in the frequency domain by the selective removal of the noise portion of the signal which corresponds to the frequency responses of the signal at frequencies outside that expected for the signal portion which is of interest. Time conversion 205 of the frequency segments is conducted by first performing an inverse Discrete Fourier Transform, and then applying a composite window function, consisting of the inverse of the first window function combined with the second window function. The output signal 206 is constructed by summing the resulting time segments at the appropriate overlap proportion to ensure good reconstruction of the signal.

With reference to FIG. 3, in an embodiment of the signal processing method, time segments overlapping by a specified proportion are formed 302 from an input signal received at step 301. Conversion 303 of the time segments into the frequency domain is achieved by applying the first window function and then performing a Discrete Fourier Transform on each of the time segments. Frequency padding 304 is then performed in the frequency domain by appending the signal with a string of zero-valued frequency samples. Time conversion 305 of the frequency segments is conducted by first performing an inverse Discrete Fourier Transform, and then applying a composite window function, consisting of the inverse of the first window function combined with the second window function. The output signal 306 is constructed by summing the resulting time segments at the appropriate overlap proportion to ensure good reconstruction of the signal.

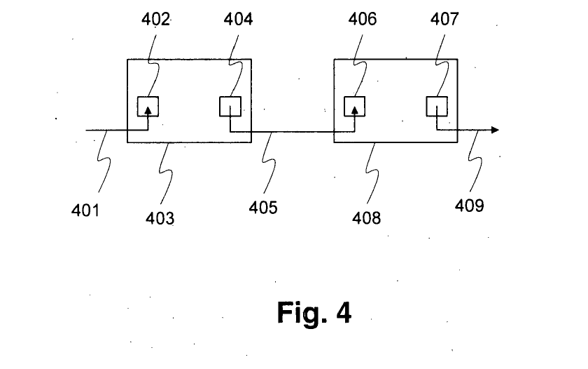

With reference to FIG. 4, in an embodiment of the signal processor, there is a signal sampling unit 403 which has an input port 402 for receiving an input signal 401. The signal sampling unit 403 is configured to obtain signal segments from the input signal 401. The signal sampling unit 403 has an output port 404 which is connected 405 to the input port 406 of a processing unit 408. The processing unit 408 is configured to efficiently manipulate the time-domain signal segments received from the signal sampling unit 403, by using a conversion into the frequency domain. The processing unit 408 has an output port 407 for outputting an output signal 409. In this embodiment, the processing unit 408 is a digital signal processing unit which may, for example, be implemented by a Field Programmable Gate Array (FPGA).

1. A signal processing method comprising:
forming a plurality of overlapping time segments representing an input signal;
applying a first window function to each of the overlapping time segments and converting the windowed overlapping time segments into respective frequency segments;
converting each of the respective frequency segments to respective time segments; and
applying a composite window function to each of the respective time segments and combining the windowed respective time segments to produce an output signal,
wherein the composite window function is a combination of an inverse of the first window function and a second window function, the second window function summing to a constant value when overlapped by a same overlap as the overlaps of the overlapping time segments.

2. The signal processing method of claim 1, wherein the second window function is a function that adds to a constant value using an overlap of 50%.

3. The signal processing method of claim 1, wherein the first window function is a four term window function.

4. The signal processing method of claim 1, wherein there is a 50% overlap between the time segments formed from the input signal.

5. The signal processing method of claim 1, wherein the first window function is the Blackman Harris Window function.

6. The signal processing method of claim 1, wherein the second window function is the Hann Window function.

7. The signal processing method of claim 1, wherein the conversion of the windowed overlapping time segments into respective frequency segments is carried out using a Discrete Fourier Transform.

8. The signal processing method of claim 1, wherein the conversion of the respective frequency segments to respective time segments is carried out using an inverse Discrete Fourier Transform.

9. The signal processing method of claim 1, further comprising manipulating the respective frequency segments before converting them to respective time segments.

10. The signal processing method of claim 9, wherein the overlapping time segments representing the input signal have a first sampling rate and the respective time segments have a second sampling rate, and wherein the second sampling rate is different from that of the first sampling rate.

11. The signal processing method of claim 9, wherein the input signal comprises a signal portion and a noise portion, and wherein frequency components corresponding to the noise portion are removed from the respective frequency segments in the frequency domain to increase the ratio in the output signal between the signal portion and the noise portion compared to the ratio in the input signal between the signal portion and the noise portion.

12. A signal processor configured to:
receive an input signal;
form a plurality of overlapping time segments representing the input signal;
apply a first window function to each of the overlapping time segments and convert the windowed overlapping time segments into respective frequency segments;
convert each of the respective frequency segments to respective time segments; and
apply a composite window function to each of the respective time segments and combine the windowed respective time segments to produce an output signal,
wherein the composite window function is a combination of an inverse of the first window function and a second window function, the second window function summing to a constant value when overlapped by a same overlap as the overlaps of the overlapping time segments.

13. The signal processor of claim 12, wherein the second window function is a function that adds to a constant value using an overlap of 50%.

14. The signal processor of claim 12, wherein the overlapping time segments representing the input signal have a first sampling rate and the respective time segments have a second sampling rate, and wherein the second sampling rate is different from that of the first sampling rate.

15. The signal processor of claim 11, wherein the overlapping time segments are formed from the input signal using a signal sampling device.

16. (canceled)

17. (canceled)
